(19) United States
(12) Patent Application Publication
(10) Pub. No.: US 2012/0080885 A1
(43) Pub. Date: Apr. 5, 2012

(54) ROTOR FOR A POWER GENERATOR, IN PARTICULAR FOR WIND TURBINES

(75) Inventor: Nordine Haddjeri, Marseille (FR)

(73) Assignee: NHEOILS (Societie par Actions (Simplifee), Aix En Provence (FR)

(21) Appl. No.: 13/259,803

(22) PCT Filed: Mar. 26, 2009
(86) PCT No.: PCT/FR09/00331

§ 371 Date: Dec. 5, 2011

(51) Int. Cl. F03D 9/00; F01D 5/00

(52) U.S. Cl. 290/55; 416/23

(57) ABSTRACT

The invention relates to a rotor for fluid flow power generator comprising a plurality of blades obliquely oriented relative to the axis of the rotor, characterized in that it comprises means for varying the obliqueness of the blades.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention relates to a rotor for a power generator, in particular electrical power, based on a fluidic flow capable of being air or water in particular. It relates more specifically to a wind turbine rotor. It also applies to an electrical power generating device, in particular a wind turbine, comprising a generator coupled to at least one rotor.

2. Description of Related Art Including Information Disclosed Under 37 CFR 1.97 and 37 CFR 1.98.

Environmental concerns and rising prices of fossil fuels have led, in recent years, to an increase in interest in alternative forms of energy, in particular in the field of wind turbines.

The most common wind turbine solutions consist of wind turbines with a horizontal axis having a propeller perpendicular to the wind and mounted on a wind tower.

This technology is often used for large installations for generating a large amount of electrical power.

Lower-profile solutions have been proposed, in particular for installations near buildings consuming electrical power. This is the context of the device described in document FR A 2 872 867, disclosing a machine for generating power by means of wind force, in the form of a wind generator having a rotor of which the blades have a semi-frusto-conical shape and are quasi-parallel to the axis of rotation. Essentially used with a horizontal axis of rotation, this type of device is highly efficient and compact, making it suitable for multiple installation areas in particular on building rooftops.

The blades of this type of generator are, however, large and therefore have a large surface of contact with the fluid, involving mechanical strength considerations requiring sizing of the structures suitable for taking up the stresses produced by winds of highly variable force.

The invention proposed here is intended to improve the technology of rotors with blades positioned obliquely with respect to the axis of the rotor.

U.S. Pat. No. 4,159,191 describes a rotor for a power generator based on a fluid flow, comprising a plurality of flexible blades positioned obliquely with respect to the axis of the rotor, which is arranged so as to allow for a variation in the obliqueness of the blades, during operation. More specifically, the front end of the blades is rigidly attached on a circular crown, while the remaining portion thereof is free. In this way, the blades are mounted so as to float, by means of their front ends, on the circular crown, itself rigidly connected to the horizontal rotary shaft of the rotor. According to the force of the wind engulfing in the front opening of the rotor defined by the circular crown, the rear free end of the flexible blades moves away from or toward the horizontal rotary shaft. There is therefore a variation in the obliqueness of the blades of the rotor, but this possible variation of the obliqueness cannot be considered to be an adjustment of the latter. Such a solution appears to be purely theoretical and does not appear to have led to practical applications. A construction enabling satisfactory, lasting and quiet operation of such a rotor applied to wind turbines indeed appears to be very difficult to obtain.

### BRIEF SUMMARY OF THE INVENTION

The invention provides a solution to the aforementioned problems of the wind turbine machines having blades positioned obliquely.

In particular, the invention has the advantage of making it easy to adapt the fluid flow rate, which can be highly variable in particular when wind is concerned.

To this end, the configuration of the rotor recommended in this document changes according to the force of the wind, protecting the electrical generation installation from risks of breakage of the rotor and making it possible to optimize the structure of the assembly, in particular with regard to the mechanical stresses imposed by the wind. The applicant has thus noted that it was possible to clearly reduce the weight of the rotor by implementing the invention while maintaining sufficient mechanical reliability.

Other objectives and advantages will appear in the description, which presents a detailed embodiment of the invention, which embodiment cannot however be considered to be limiting.

It is first noted that the present invention relates to a rotor for a power generator based on a fluid flow comprising a plurality of blades positioned obliquely with respect to the axis of the rotor, characterized in that it comprises means for controlling the variation in the obliqueness of the blades.

According to preferred but non-limiting alternatives, this rotor is such that:
the means ensuring the variations in inclination of the blades are controlled so as to slave the obliqueness of the latter to the speed of the fluid flow,
the blades have a generally semi-frusto-conical shape,
the obliqueness of the blades is variable in a plane substantially perpendicular to the plane defined by the longitudinal edges of the blades,
the device comprises a shaft according to the axis of the rotor and means for connection between the shaft and each blade,
the connection means comprise, for each blade, a hinge near the leading edge of the blade and at least one variable downstream connection,
the variation means comprise means for modifying the length of the downstream connections,
the variation means comprise means for modifying the position of the connections along the shaft,
the obliqueness of the blades is variable between 0 and 45°,
the leading edge of the blades forms an angle of between 20 and 30° toward the outside with the plane normal to the longitudinal axis of the blades,
the trailing edge of the blades forms an angle of between 20 and 30° at the outside with the plane normal to the longitudinal axis of the blades.

The invention also relates to an electrical power generating device comprising a generator coupled to at least one rotor as defined above.

The appended drawings are provided as examples and do not limit the invention. They merely represent an embodiment of the invention and will enable it to be understood easily.

### BRIEF DESCRIPTION OF THE DRAWINGS

FIG. 1 shows a perspective view of a first configuration of the invention that can be applied to fluid flows of average speed.

FIG. 2 shows a view according to direction F.

FIG. 3 shows a perspective view of the invention in the case of a more powerful fluid flow.

FIG. 4 is a view according to direction E.

FIGS. 5 and 6 show two different inclinations of a blade of a rotor according to the invention.

FIGS. 8 and 9 show an alternative of the invention in comparison with the embodiment diagrammatically shown in FIG. 7.

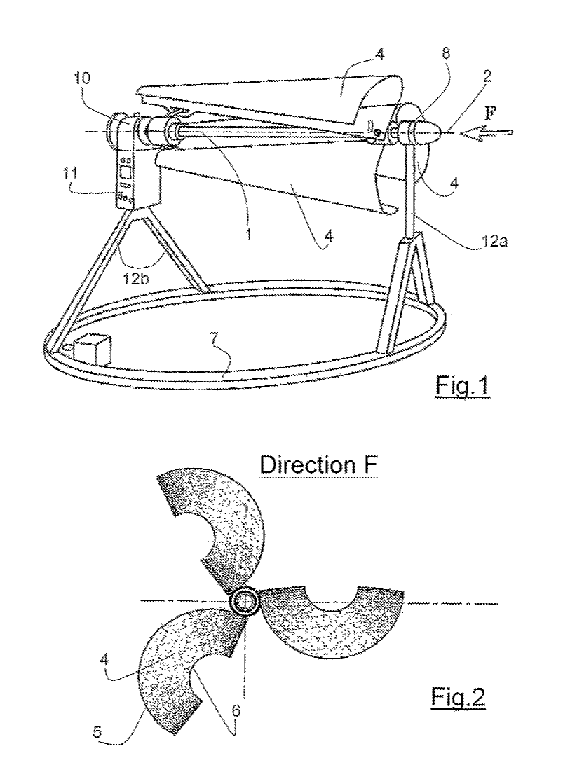

### DETAILED DESCRIPTION OF THE INVENTION

The rotor presented here comprises a plurality of blades 4 shown in the various figures and having a longitudinal direction with a non-zero component according to the axis of rotation 2 of the rotor. In this way, the blades 4 are formed obliquely with respect to the axis of the rotor.

Each blade 4 extends longitudinally toward the rear from its front end or leading edge 5 and radially outwardly, so as to progressively move away from the axis of rotation 2. The obliqueness of the blades thus positioned can vary between 0 and 45°.

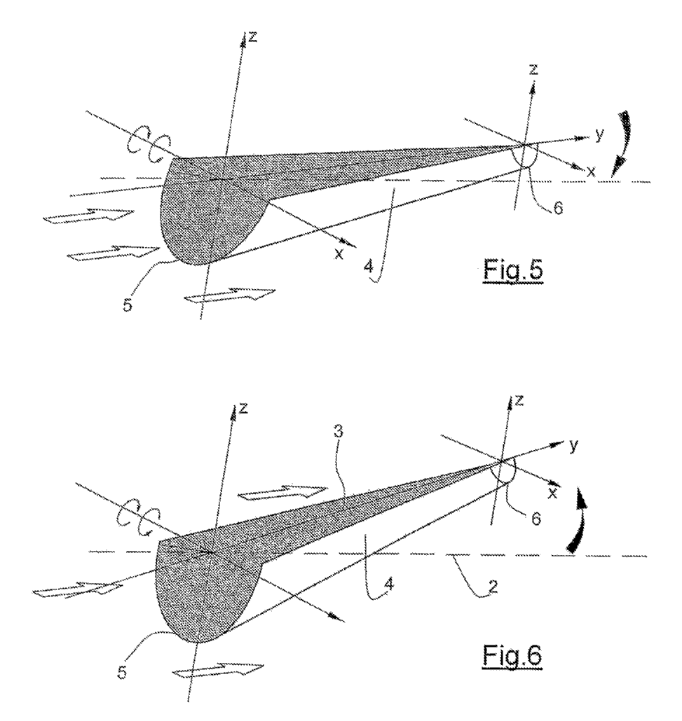

In the case shown, three blades 4 are provided, but this number is non-limiting. In addition, the example shown has 4 identical blades, uniformly distributed and produced by a semi-frusto-conical casing that is slightly convoluted between the leading edge 5 and the trailing edge 6 by an angle of between 20 and 30°. The blades 4 are angularly offset with respect to the direction defined by the axis of rotation 2 by an angle on the order of 5 to 15° in the XY plane shown in FIGS. 5 and 6.

By way of indication, the diameter of the base of the cone frustum used to form the leading edge 5 is on the order of 0.25 times the length of the blade while the diameter of the apex of the cone frustum used to produce the trailing edge 6 is on the order of 0.083 times said length.

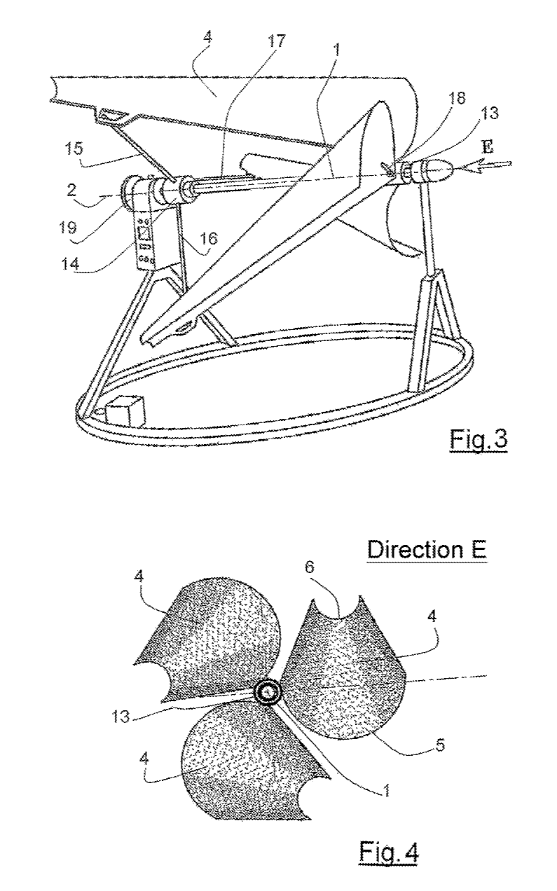

The rotor thus formed by these blades 4 rotating about the axis 2 formed by the shaft 1 can be used in particular in an electrical power generating device, in particular for wind turbines. In this context, and as shown in particular in FIGS. 1 and 3, the shaft of the rotor is coupled to a generator 10 enabling electrical power to be produced. The assembly is pivotably mounted around a vertical axis, so as to enable it to be positioned automatically in the direction of the wind.

According to the embodiment shown, the assembly is supported by a base 7 connected by support arms 12a, 12b with a substantially vertical position, to front 8 and rear 9 bearings guiding the rotation of the shaft 1. The base 7 is itself advantageously pivotably mounted so as to perform a wind vane function and adapt to the direction of the wind when the fluid flow is of the wind energy type.

An electrical box 11 is also represented for the control of the assembly. This box may be at the base of the wind tower used to raise the wind turbine if necessary.

According to the invention, the configuration of the rotor can be modified according to the fluid flow rate. In particular, the obliqueness of the blades 4 is variable and advantageously slaved to the flow rate.

The variation in the obliqueness of the blades is preferably performed in the YZ plane shown in FIGS. 5 and 6, formed by a plane substantially perpendicular to the plane defined by the longitudinal edges of the blades.

Also preferably, for dynamic balancing reasons, the variation in obliqueness is identical and simultaneous for each of the blades 4.

Different means for controlling the variation in this obliqueness can be provided.

In reference to the drawings, an embodiment has been shown in which each blade 4 is connected to the shaft 1 by means of a coupling member 13, in particular by a pivot hinge 18.

This hinge can be produced by means of a device with a threaded axis, also optionally capable of being moved in an oblong hole formed on the blade so as also to enable the obliqueness to be adjusted according to a direction XY in reference to FIGS. 5 and 6.

Further behind the rotor, a coupling member 14 mounted on the shaft 1 cooperates with connections 15, 16, 17 each connecting the coupling member 14 to a blade 4. Preferably, the member 14 acts as a hub.

Preferably, the ends of each connection are pivotably connected in a swivel joint with respect to the coupling member 14 and the upper surface of the blades 4.

As diagrammatically shown, the variation in obliqueness of the blades 4 is produced by a variation in the length of the connections 15, 16, 17. To this end, each connection can include an electrical, pneumatic or hydraulic and controlled cylinder.

According to an alternative solution, the coupling member 14 can be moved along the shaft 1 so as to modify the inclination of the connections 15, 16, 17 causing the trailing edges 6 to move toward or away from the shaft 1.

Although the control may be manual, it is advantageous to provide automatic means capable of producing the variation in obliqueness of the blades 4, so that the rotation speed is quasi-constant. To this end, the installation advantageously comprises means for measuring the fluid flow rate, in particular in the form of an electronic anemometer in the case of a wind turbine installation. These measurement means are connected to a servo circuit capable of producing an output signal for controlling means ensuring the variation in obliqueness. These means for maneuvering the blades can be mechanical, electromechanical, pneumatic or hydraulic.

It is easily understood that once a variation in speed is measured, the configuration of the rotor is adapted in particular so as to reduce the obliqueness in the event of strong winds. Providing less resistance to the air, the blades 4 are subject to lower mechanical stresses than if they remained in a more oblique position.

Advantageously, the obliqueness can be adjusted between 0° and 45°.

In addition, the orders for controlling the actuation of the blades are advantageously routed by means of the rotation shaft 2 which is hollow.

In addition to the optimal recovery of the energy of the fluid, regardless of the force of the flow, the invention enables greater safety by moving the angle of obliqueness toward 0. It is also possible to associate a disk brake 19 with hydraulic or mechanical control installed at the end of the shaft 1 under the wind. Uncontrolled mechanical vibrations that currently may occur if the rotation speed is excessive are also prevented. A reduction in the noise level is also observed due to a quasi-constant rotation speed. This constancy also improves the reliability of the assembly.

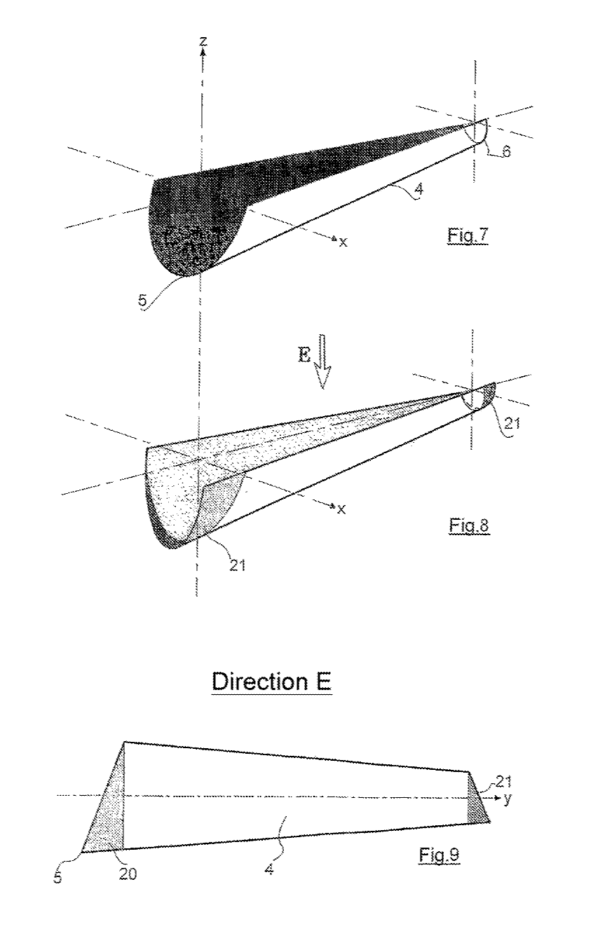

FIGS. 8 and 9 show an alternative embodiment of the downstream 21 and upstream 20 external borders extended with respect to the plane (x, z).

In the specific example described above, under average winds, the obliqueness may have a value of around 30°. At this value, the leading edge will be in a plane containing the perpendicular to the blade passing through the axis of rotation and forming an angle of 25° with said axis, in front of the blade. The effect of this is that the external border of the blade is extended and thus increases the effective surface of the blade 4 by approximately 6%, further improving the energy efficiency.

1. Rotor for a power generator based on a fluid flow, in particular for wind turbines, comprising a plurality of blades positioned obliquely with respect to the axis of the rotor, in which each blade extends longitudinally toward the rear from its front end or leading edge and radially outwardly, so as to progressively move away from the axis of rotation of said rotor, characterized in that it comprises means for controlling the variation in obliqueness of the blades and means for measuring the fluid flow rate, which measurement means are connected to a servo circuit capable of producing an output signal for controlling the maneuvering means ensuring the variation in obliqueness of the blades, so as to enslave the obliqueness of the latter to the fluid flow rate.

2. Rotor for a power generator based on a fluid flow, according to claim 1, characterized in that the means for measuring the fluid flow rate comprises an electronic anemometer.

3. Rotor according to claim 1 in which the blades have a generally semi-conical shape.

4. Rotor according to claim 3, in which the obliqueness of the blades is variable in a plane substantially perpendicular to the plane defined by the longitudinal edges of the blades.

5. Rotor according to claim 1, comprising a shaft according to the axis of the rotor and connection means between the shaft and each blade.

6. Rotor according to claim 5, in which the connection means comprise, for each blade, a hinge near the leading edge of the blade and at least one variable downstream connection.

7. Rotor according to claim 6, in which the variation means comprise means for modifying the length of the downstream connections.

8. Rotor according to claim 6, in which the variation means comprise means for modifying the position of the connections along the shaft.

9. Rotor according to claim 1, in which the obliqueness of the blades is variable between 0° and 45°.

10. Rotor according to claim 1, in which the leading edge of the blades forms an angle between 20° and 30° toward the outside with the plane normal to the longitudinal axis of the blades.

11. Rotor according to claim 1, in which the trailing edge of the blades forms an angle between 20° and 30° at the outside with the plane normal to the longitudinal axis of the blades.

12. Electrical power generating device, in particular a wind turbine, comprising a generator coupled to at least one rotor according to claim 1.
